(19) United States
(12) Patent Application Publication
(10) Pub. No.: US 2016/0224911 A1
(43) Pub. Date: Aug. 4, 2016

(54) SERVICE PROVIDER EMERGING IMPACT AND PROBABILITY ASSESSMENT SYSTEM

(71) Applicant: BANK OF AMERICA CORPORATION, CHARLOTTE, NC (US)

(72) Inventors: James Edward Rush, Saluda, NC (US); Andrew John McGowan, Charlotte, NC (US); Dennis Paul Weigel, Matthews, NC (US)

(21) Appl. No.: 14/614,272

(22) Filed: Feb. 4, 2015

(51) Int. Cl. G06Q 10/06

(52) U.S. Cl. CPC G06Q 10/0635

(57) ABSTRACT

The present invention embraces a system including a processing device, a memory, and a communication device in communication with a distributed network. The system is configured for assessing and managing risk for a multitude of service providers by receiving service provider information from network feeds over a distributed network and storing such information in a data store prior to analyzing such information to determine an amount of risk an organization assumes based on receiving products or services from a service provider and communicate such information for storage in a data store. The system may further determine risk mitigation controls that may be enacted by an organization in order to mitigate the risk associated with receiving the products or services form the service provider. The system may further generate and present a graphical representation of data relating to the risk.

### FIELD OF THE INVENTION

The present invention embraces a system comprising a processing device, memory, and a communication device in communication with a distributed network. The system assesses and manages risk for the multitude of service providers by receiving service provider information from network feeds over a distributed network and storing such information in a data store located within the distributed network. The system analyzes such information to determine an amount of risk an organization assumes based on the organization receiving products or services from the multitude of service providers.

### BACKGROUND

Various methods exist to help businesses assess the business risks associated with service providers. A need exists for an improved system for assessing risk from a service provider.

### SUMMARY

The present invention embraces a system comprising a processing device, memory, and a communication device that is in direct communication with a distributed network. The system is configured to connect and communicate with servers and other computing devices over the distributed network to receive and store service provider information necessary to calculate risk that an organization may assume based on receiving a product or service form a multitude of service provider. In some embodiments, the system receives information from a third party computing device that tracks information related to the multitude of service providers. In another embodiment, the system receives information from the service provider directly. While in other embodiments, the system provides a graphical user interface to a user to submit information related to a service provider. The information may be stored in a data store that is contained within the distributed network. The data store on the distributed network contains the service provider risk information.

In some embodiments, the system further determines at least one risk area associated with a business practice of the multitude of service providers.

In other embodiments, the system determines at least one risk factor associated with the multitude of service providers, wherein the risk factor is a result of the organization receiving a product or service from the multitude of service providers.

In some embodiments of the invention, the system calculates an inherent risk score for each of the multitude of service providers based on the service provider information, wherein the inherent risk score is based at least on risk area and the at least one risk factor.

In other embodiments, the system identifies risk mitigation controls for each of the multitude of service providers to an impact of the at least one risk factor and a probability of a risk event occurring in the at least one risk area.

In some embodiments, the system calculates a residual risk score for each of the multitude of service providers based on the service provider information and identifying the risk mitigation controls for each of the multitude of service providers.

In other embodiments, the system presents a graphical representation of at least the inherent risk score and the residual risk score for at least one of the multitude of service providers to a user computing device.

The system enables an organization to mitigate risk from receiving the product or service from the service provider.

In some embodiments, the system may be further configured for calculating an impact score for each of the multitude of service providers based on the risk information and based on the at least one risk factor and determining for each of the multitude of service providers the probability of a risk event occurring in the at least one risk area based on the risk information. Based on calculating the probability of the risk event occurring for the multitude of service providers, the system may be configured to calculate a probability risk score for the least one risk area Using the probability risk score and the impact score, the system may be configured to determine an inherent risk area score for the at least one risk area based on the impact score. Additionally, the system calculates the inherent risk score for each of the multitude of service providers based on the inherent risk area score for the at least one risk area.

In other embodiments, the system may be further configured for calculating a residual impact score for each of the multitude of service providers based on the risk information and the risk mitigation controls. The system may also determine a probability of a risk event occurring within a risk area based on the risk information and the risk mitigation controls. Based on determining the probability of a risk event occurring, the system may be configured to calculate a residual probability risk score for the least one risk area. Using the residual probability risk score and the residual impact risk score, the system may determine a residual risk area score for the at least one risk areas. Additionally, the residual risk score for each of the multitude of service providers is based on the residual risk area score for the at least one risk area.

In some embodiments, a service-provider system is in communication with the distributed network and a data server of the organization is in communication with the distributed network. Based on such, the system may determine the at least one risk factor comprises determining whether the service-provider system has access to the data server of the organization.

In some embodiments, the inherent risk score for each of the multitude of service providers comprises an inherent risk area score associated with each risk area and the residual risk score for each of the multitude of service providers comprises a residual probability risk area score associated with each risk area. Additionally, the graphical representation is a radar chart, and the chart displays at least the inherent risk area scores and the residual risk area score for at least one of the multitude of service providers.

In some embodiments, the graphical representation is a Pareto chart, which displays the inherent risk score and the residual risk score of each of the multitude of service providers. The Pareto chart ranks the multitude of service providers based on the inherent risk score of each of the multitude of service providers.

In other embodiments, the service provider risk management system of claim 1, wherein the organization is a financial institution.

### BRIEF DESCRIPTION OF THE DRAWINGS

Having thus described embodiments of the invention in general terms, reference will now be made the accompanying drawings, wherein:

FIG. 1 depicts a service provider risk management system and operating environment in accordance with an exemplary embodiment of the present invention;

FIG. 2 schematically depicts a service provider risk management system in accordance with an exemplary embodiment of the present invention;

FIG. 3 depicts a radar chart showing an inherent risk score and a residual risk score of a service provider;

FIG. 4 depicts a Pareto chart showing inherent risk scores and residual risk scores of a multitude of service providers;

FIG. 5 depicts a method of assessing and managing risk for a multitude of service providers in accordance with an exemplary embodiment of the present invention; and

FIG. 6 depicts a method for determining an inherent risk score for a service provider.

FIG. 7 depicts a method determining a residual risk score for a service provider.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that engage in risk assessment and management.

A “user” may be any person or entity using a service provider risk management system described herein. Often, a user is an employee of an entity (e.g., a financial institution) using a service provider risk management system. In some instances a user has a management position within an entity using a service provider risk management system.

A “service provider” may be any person or entity that offers a product and/or service. The service provider may offer service in conjunction with a product offered by the service provider or a third-party. The service offered by the service provider may be a software solution. The software may be a licensed product which is installed on a computing device not maintained by the service provider. Additionally, the software may comprise a licensed subscription to software that is managed by the service provider or a third party such as Software as a Service (SAAS). The service provider may provide access to the software application and store data on behalf of a customer. The product or service may also be access to a computing device hardware solution such as a virtual machine, a hosted machine, a collocated machine, and a cloud based computing device. The service provider may provide access to a customer to install and manage software applications on such a hardware platform.

An “inherent risk score” is defined as a measurement to determine the amount of risk an organization assumes by receiving products or services from a service provider.

A “residual risk score” is defined as a measurement to determine the amount of risk an organization assumes by receiving products or services from a service provider after enacting risk mitigation controls.

A “risk mitigation control” is any action or potential action that an organization may enact in order to mitigate the effect or probability of an occurrence of a risk event as a result of such organization being a client of a particular service provider.

A “risk event” is defined as any event that may result in a loss to an organization. The loss may be financial, reputation, strategic, or the like.

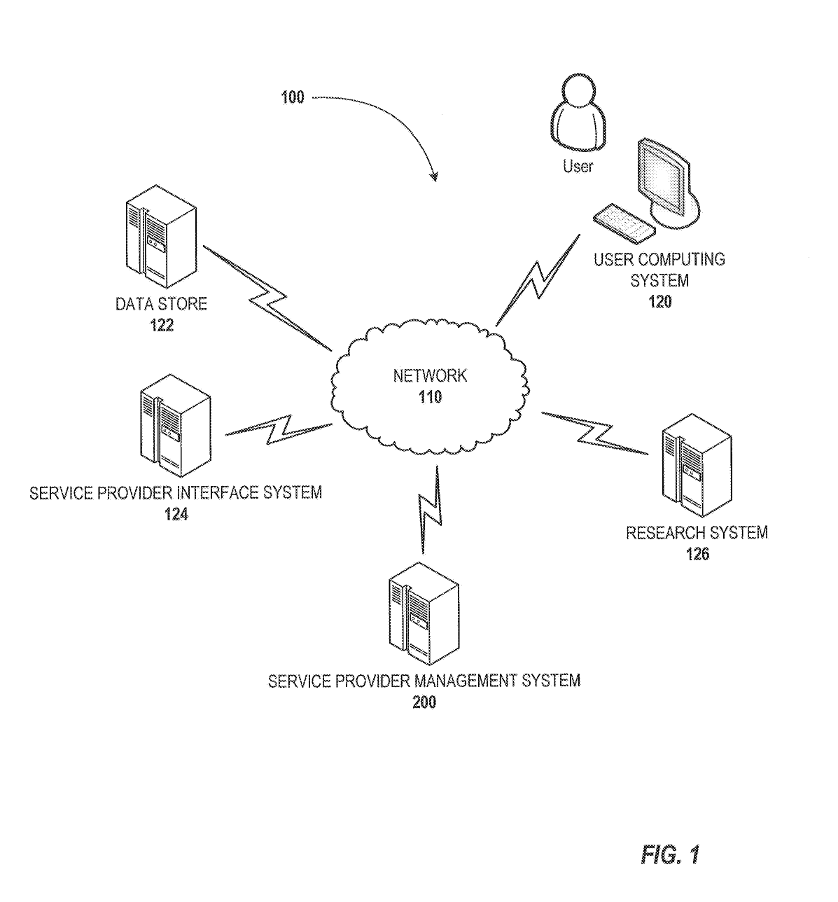

In one aspect, the present invention embraces a service provider risk management system that may be used by an organization, such as a financial institution, to engage in risk assessment and management of service providers that provide products and/or services to the organization. In particular, the service provider risk management system that may be used to detect service providers that are considered high risk. In this regard, FIG. 1 depicts an operating environment 100 according to one embodiment of the present invention that facilitates risk management for an organization (e.g. a financial institution). The operating environment 100 includes a service provider risk management system 200, a data store 122, a service provider interface system 124, a user computing device 120 and a research system 126.

The network 110 may be a global area network (GAN), such as the Internet, a wide area network (WAN), a local area network (LAN), or any type of network or combination of networks. The network 110 may provider wireline, wireless, or a combination wireline and wireless communication (e.g., using IP based connectivity) between devices on the network.

As illustrated in FIG. 1, the service provider risk management system 200 may be operatively coupled via the network 110 to the data store 122, the service provider interface system 124, the user computing device 120, and the research system 126. The service provider risk management system 200 may be configured to send information to and receive information from the data store 122, the service provider interface system 124, the user computing device 120, and the research system 126. The network 110 may be a distributed network.

FIG. 1 illustrates a data store 122 which is used to store information collected over the network. In some embodiments, the data store 122 may be a database. While in other embodiments, the data store may be an electronic file system. In any event, the data store is typically a persistent storage medium. The data store 122 may be capable of receiving and communicating over the network 110 with over devices located on the network. In some embodiments, the data store may be restricted in communicating and receiving information across the network 110. The data store 122 may house information related to a multitude of service providers which may include risk information.

FIG. 1 further illustrates a service provider interface system 124. The service provider interface system 124 represents a computing device that is accessible over the network 110. In some embodiments, the service provider interface system 124 is managed internally within an organization and is configured with a software product from a service provider. In another embodiment, the service provider interface system 124 is managed by a service provider where the service provider providers access to an organization. In any embodiment, the service provider interface system may 124 communicate with computing devices of the organization via the network 110 in order to provide a service to such organization. In some embodiments, the system 124 receives organizational data which is stored and managed by the system 200.

Further illustrated in FIG. 1 is a research system 126. A research system may supply information to the service provider risk management system 200 over the network for use by the service provider risk management system as described within this application. The research system may be managed by a third party which is neither a service provider nor the organization which manages the service provider risk management system 200. The research system 126 may be configured to collect and compile data relating to a multitude of service providers.

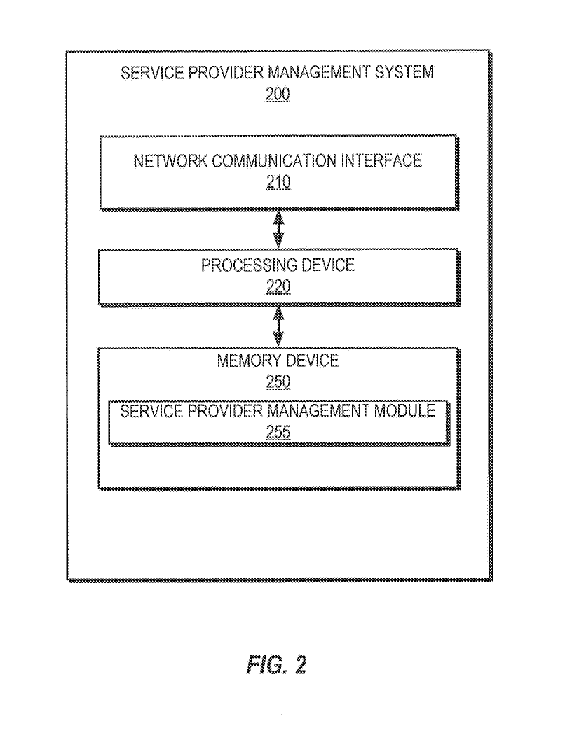

FIG. 2 depicts the service provider risk management system 200 in more detail. As depicted in FIG. 2, the service provider risk management system 200 typically includes various features such as a network communication interface 210, a processing device 220, and a memory device 250. The network communication interface 210 includes a device that allows the service provider risk management system 200 to communicate over the network 110 (shown in FIG. 1) with the user computing devices 120 and the other devices on the network. In this regard, an interface (e.g., a graphical user interface) is typically presented on each user computing device to allow each user to interface with the service provider risk management system.

As used herein, a “processing device,” such as the processing device 220, generally refers to a device or combination of devices having circuitry used for implementing communications and/or logic functions of a particular device, a microprocessor device, and various analog-to-digital converters, digital-to-analog converters, and other support circuits and/or combinations of the foregoing. Control and signal processing functions of the system are allocated between these processing devices according to their respective capabilities. The processing device 220 may further include functionality to operate one or more software programs based on computer-executable code thereof, which may be stored in a memory. As the phrase is used herein, a processing device 220 may be “configured to” perform a certain function in a variety of ways, including, for example, by having one or more general purpose circuits perform the function by executing particular computer-executable program code embodied in computer-readable medium, and/or having one or more application-specific circuits perform the function.

As used herein, a “memory device”, such as the memory device 250, generally refers to a device or combination of devices that store one or more forms of computer-readable media for storing data and/or computer-executable program code/instructions. Computer-readable media is defined in greater detail blow. For example, in one embodiment, the memory device 250 includes any computer memory that provides an actual or virtual space to temporarily or permanently store data and/or command provided to the processing device 220 when it carries out its function described herein.

As noted, the service provider risk management system 200 is configured to perform risk assessment and management of a multitude of service providers. Accordingly, the service provider risk management system 200 typically includes one or more modules stored in the memory device 250, which facilitate risk assessment and management of the multitude of service providers. As depicted in FIG. 2, the service provider risk management system 200 typically includes a service provider risk management module 255.

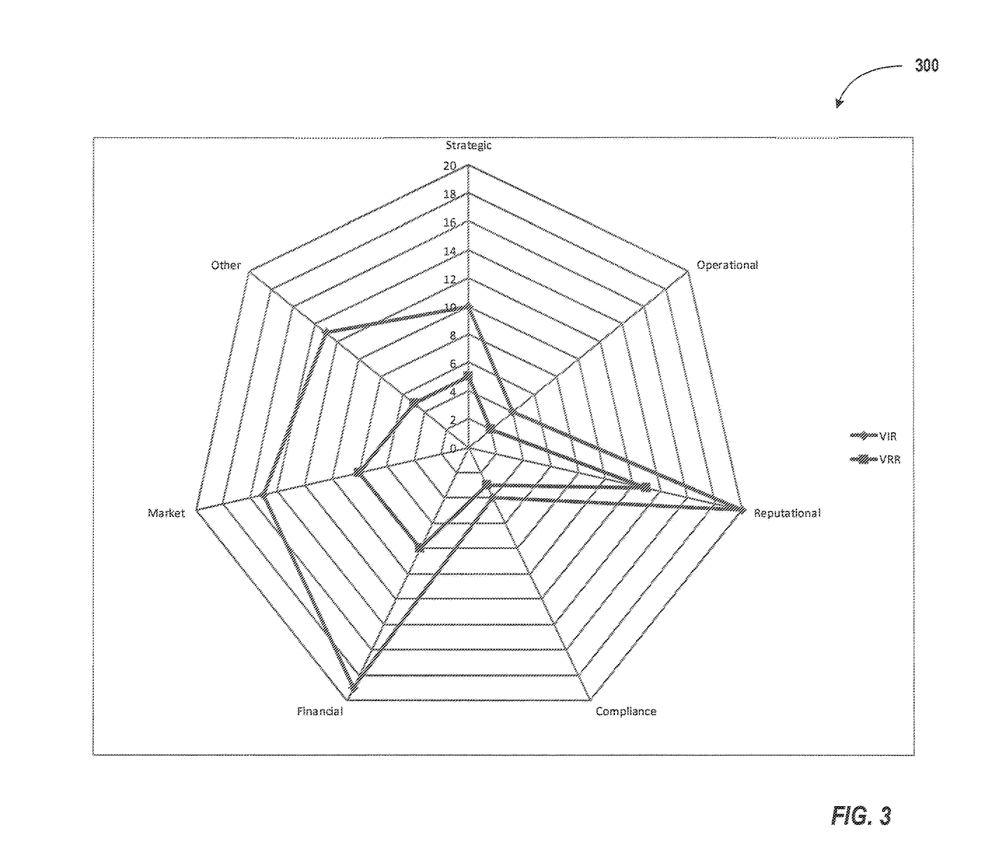

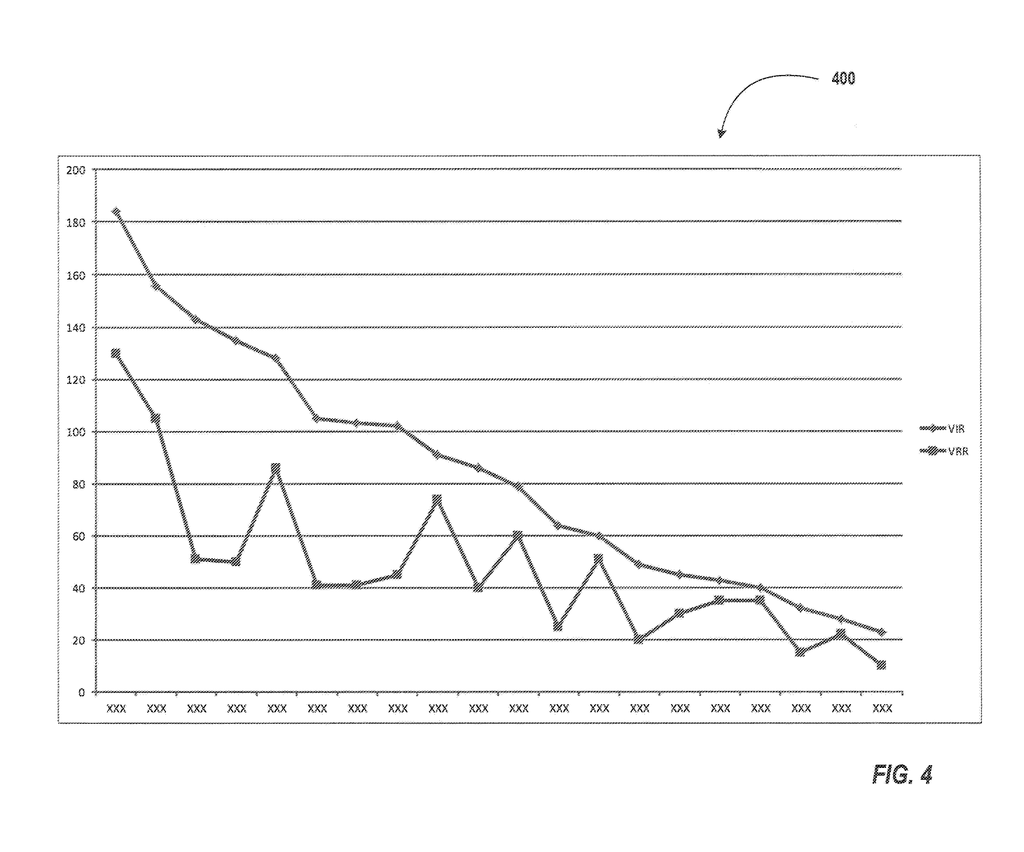

The service provider risk management module 255 is typically configured so that one or more users can interact (e.g., via user computing devices) with the service provider risk management system 200. In particular, the service provider risk management module 255 is typically configured to communicate requests via the network to the research system 126, and the data store 122 in order to collect the necessary information relating to a multitude of service providers in order to perform the necessary calculations as described herein. In addition, the service provider management module may further be configured to receive such information via the network 110 which is may further communicate to the data store 122 for persistent storage. The service provider risk management module 255 may further cause the service provider risk management system to communicate with the user computing device 120 via the network 110 in order to display service provider information to a user. Such information may be a displayable graphical user interface which is displayed on the screen of the user computing device 120. The graphical user interface may also permit the user to upload service provider information and generate service provider risk reports. Additional information may include graphs and charts similar to that of FIG. 3 and FIG. 4.

As depicted in FIG. 3, the inherent risk score and the residual risk score may be graphically presented to a user in the form of a radar chart 300. In FIG. 3, a line representing each of the risk management areas extends from the center of the radar chart 300. Accordingly, each line is segmented to represent different values of risk for each of the risk management areas with the center of the radar chart 300 representing zero or the lowest amount of risk and the extent of the line representing the maximum amount of recorded risk for a given organization. The lines are equally spaced in a radial fashion extending from the center of the radar chart 300. For each of the risk management areas a plot is placed on a coordinating line representing the amount of risk for the risk management area. The plots are connected using a radial line to present an enclosed shape corresponding to a total amount of risk. The radar chart 300 comprises two sets of radial lines. The first line represents the inherent risk score for the service provider. The second radial line represents the residual risk score of the service provider. The radar chart 300 visually represents the impact of implementing controls available to manage the risk in each of the risk areas. Therefore, the residual risk score radial line will typically be less than or equal to that of the inherent risk score radial line. The distance between the residual risk score and the inherent risk score represents the amount that the risk in a given risk management area was reduced based on implements the risk mitigation controls. In some embodiments, additional radial lines may be presented on the radar chart 300 depicting the effect of implementing one or more of the risk mitigation controls for a given risk management area. These radial lines will typically lay between the residual risk score and the inherent risk score radial lines.

As depicted in FIG. 4, the inherent risk score and the residual risk score may also be depicted for each of the multitude of service providers using a Pareto chart. In FIG. 4, the y-axis represents the total amount of risk for either the inherent risk score or the residual risk score. The x-axis comprises the multitude of service providers. A plot is made for each service provider on the Pareto chart 400 corresponding to either the inherent risk score or residual risk score of the service provider. Typically, the service providers are ranked based on the inherent risk score of the service provider. In other embodiments, the service providers may be ranked alphabetically, or based on residual risk scores. The individual residual risk score and inherent risk score scores may be connected using a line forming the Pareto chart 400 into a line graph.

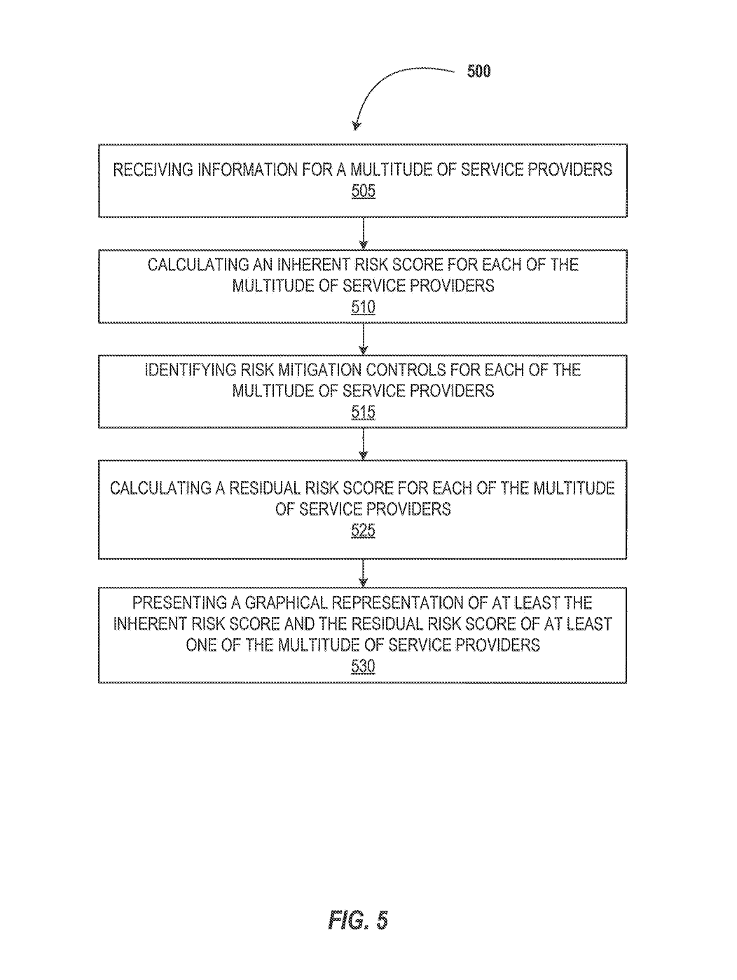

As depicted in FIG. 5, a method 500 for presenting a graphical representation of at least an inherent risk score of a service provider and a residual risk of the service provider based on identifying risk mitigation controls for the service provider.

Block 505 demonstrates receiving information for a multitude of service providers. As defined herein, a service provider may offer a product or service to an organization. In various embodiments, the product or service may be any product or service and the service provider may offer multiple products and/or services. In some embodiments, the service provider may offer service in connection with a product. In specific embodiments of the invention, the product or service may be limited to a software solution. The system 200 may receive the information for a multitude of service providers by communicating a request to the data store 122, and the research system 126 over the network 110 from which the system 200 would receive a response containing such information, as defined within this application. The system 200 may additionally present an application via the user computing device 120 to a user which permits such user to submit the information to the system 200. Such information may be received through a network data feed. The system 200, upon receiving information, may be configured to communicate the information to the data store 122 for storage.

Where the product is a software solution, the software solution may be one of many types. In one embodiment, the software solution may be a licensed product offered by the service provider to the organization. In such an embodiment, the product may be installed on one or more computing devices managed by the organization. For example, Company A is a service provider that licenses a word processor. Organization B obtains a license from Company A to install the word processor on several computers that Organization B manages. In addition to the license of the software, the service provider may also provide service in connection with the licensed software. Following the above example, in connection with receiving the license from Company A, Organization B receives a support package from Company A that allows Organization B to call a support number and receive technical support relating to issues with work processor.

In another embodiment, the software solution may be software that is managed by the service provider and the service provider provides at least partial access of the functionality of the software, such as Software as a Service (SAAS). For example, Company A manages a system that processes payments from online transactions. Company A has created an application control interface (API) which allows customers of Company A to interface with the system. Organization B obtains access from Company A to process online payments using the system. Organization B manages an internal system that interfaces with the system of Company A. In another example, Company A manages an online accounting system which is accessible by customers of Company A using a web interface. The accounting system receives information from the customer and stores the information on servers that are managed by Company A.

In yet another embodiment, the software solution may include access to hardware that is managed by the service provide. This embodiment may include colocation of the organization's hardware connected to the service provider's network infrastructure. It may also include access to a virtual private server, a shared virtual server, or a cloud based hosting option.

The service provider information may be any information related to the service provider. However, in some embodiments, the information may correlate to an amount of risk the organization assumes by patronizing the service provider. In some embodiments, the information may be generic information which identifies the service provider such as the name of the service provider, the location of the main office of the service provider, and the place of incorporation or organization of the service provider. In further embodiments, the information may also include details related to various risk areas. These areas include, but are not limited to: strategy, operation, reputation, finances, and market. The risk areas are associated with and detail specific business aspects of the service provider. For example, the operation risk area may include information about the management structure for the service provider. Additionally, the reputation risk area may include information about the time the service provider has been in business or the amount of time the service provider has offered the particular product or service.

Where the service or product relates to a software solution, the information may further include information relating to whether the service provider utilizes free or open source technologies in the development of products or services offered by the service provider.

Block 510 of method 500 demonstrates calculating an inherent risk score for each of the multitude of service providers. In some embodiments, the inherent risk score is based on the service provider information. The inherent risk score may be based on two separate risk components: 1) impact of risk; and 2) probability of risk. The impact of risk relates to the magnitude of harm that may result from the occurrence of a risk event. Probability relates to the chance of an occurrence of a risk event. The inherent risk score may take into account multiple factors to determine both impact and probability of a risk event. With respect to impact, the system 200 may take into account several risk factors in determining risk impact, these factors may include: determining whether the service provider has direct or remote access to the network systems of the organization, whether the service provider has physical access to the organization, whether the service provider engages in customer facing activities as it relates to the product or service, whether the service provider provides products or service which have a direct material impact on the ability of the organization to provider accurate financial reporting, whether the service provider develops of hosts software applications as part of their products or services which are provided to the organization, whether the service provider delivers their products or services during a temporary and/or permanent outage result in the loss of business services, whether the service provider provides products or services in multiple countries, and/or the number of contractors the service provider employs.

With respect to probability, the service provider may be scored on several risk areas which include but are not limited to: strategy, operations, reputation, compliance, finance, and market. Each of these areas may be scored using data from the data store 122 and/or the research system 126. For example, relevant data may be analyzed to product a score related to the degree of risk in each area.

In calculating the inherent risk score, the system 200 takes into account the probability score assigned to each risk area and the impact score to calculate the inherent risk score.

Block 515 of method 500 demonstrates identifying risk mitigation controls for each of the multitude of service providers. As defined herein, a risk mitigation control is any action or potential action that an organization may enact in order to mitigate the effect or probability of an occurrence of a risk event as a result of such organization being a client of a particular service provider. The risk mitigation control may be associated with a particular risk area or a particular risk factor. The risk mitigation control may relate to mitigating the probability or occurrence of a risk event, the impact of an occurrence of a risk event, or both. It should be noted that a risk mitigation control may affect more than one area or risk factor.

Block 525 of method 500 demonstrates calculating a residual risk score for each of the multitude of service providers. Similar to calculating the inherent risk score, the residual risk score is calculated based on risk impact and risk probability. The residual risk score takes into account the risk mitigation controls that have implemented to limit the amount of risk an organization assumes based on receiving products or services from a service provider. The risk probability of the residual risk score is typically based on the same risk areas as described in the inherent risk score. Additionally, the impact is typically based on the risk score factors used to determine the inherent risk score. Therefore, the system 200 may determine impact of the residual risk score based on both the risk mitigation controls and the risk factors. Further, the system may determine the probability of residual risk based on the risk areas and the risk mitigation controls.

Block 530 of method 500 demonstrates presenting a graphical representation of at least the inherent risk score and the residual risk score of at least one of the multitude of service providers. As explained herein, the graphical representation may include, but is not limited to, a Pareto chart and a radar chart. The graphical representation may be presented via a graphical user interface to the user computing device 120. The graphical user interface may include dynamic features which allow a user to select different features to update the graphical user interface. For example, the graphical user interface may provide to a user the ability to select between a series of charts which may include a Pareto chart and a radar chart. The user may select between the two charts to present information that is most comfortable to the user. Additionally, the graphical user interface may include controls to select, deselect, or filter service providers. This provides a user the ability to view service providers that are relevant to the user at a given point in time. Additional controls may include the ability to select risk areas, different scores, and the like.

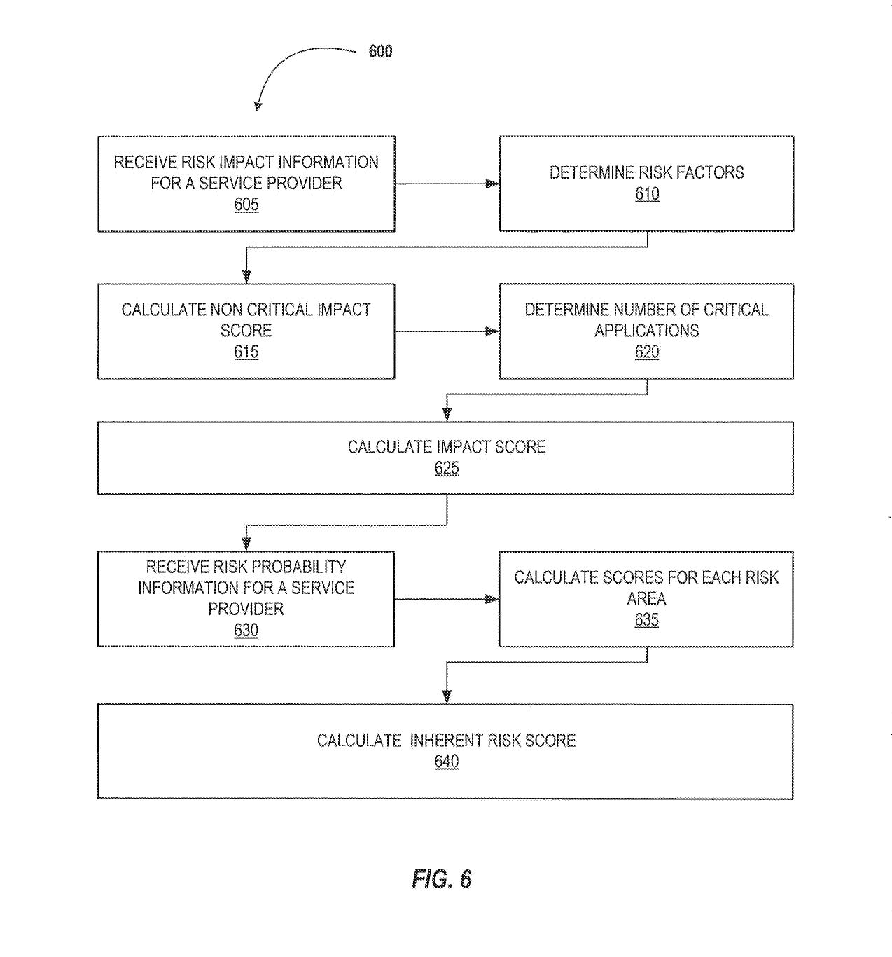

As depicted in FIG. 6, a method 600 for calculating an inherent risk score of a service provider in accordance with various embodiments of the invention. Block 605 of method 600 demonstrates receiving risk impact information for a service provider. In some embodiments, the service provider risk management system 200 may generate requests for information related to a given service provider. Such information is necessary for the service provider risk management system 200 to calculate the inherent risk score for the service provider. In some embodiments, the service provider risk management system 200 sends such a request to a research system 126. In some embodiments, the research system 126 may store the requisite information and upon receiving such the request, communicates a response to the service provider risk management system 200. The service provider risk management system 200 and the research systems 126 may communicate such requests and responses over the common network 110. The service provider risk management system 200 may be configured to communicate with the research system 126 and any manner for which the research system may be configured. For example, the research system may be configured to receive a request over the network 110 using a standard Hypertext Transfer Protocol (HTTP) POST or GET request and answer such a request using a standard web server using an Application Program Interface (API). It should be noted that the service provider risk management system 200 does not need to communicate the request directly to the research system 126. Such communication may be transmitted over the network 110 and any device that is typical in such a network. For example, where the network is the Internet, the request and response may pass through multiple computing devices before it is finally delivered. Additionally, the response and request may pass through several different server types (Proxy, Firewall, and NAT). Prior to using the information for calculating the inherent risk score, the service provider risk management system 200 may store such information in the data store 122.

In other embodiments, the service provider risk management system 200 may submit a request to the service provider to supply the necessary service provider risk information. Additionally, the information may be generated locally on a separate system or entered into the user computing device 120. Locally generated information may be stored on the data store 122, which may later be retrieved by the service provider risk management system 200 for processing.

The information comprises individual data elements which are associated with impact risk factors for a service provider. An impact risk factor describes the magnitude of loss an organization may incur based on receiving products or services from a service provider. The risk factor may be described using a Boolean operator, or may entail more sophisticated data types. In some embodiments, the service provider risk management system 200 may store in memory information related to various risk factors for a service provider. Examples of risk factors include, but are not limited to: whether a service providers use of third party products in products or services it offers, whether the service provider is regulated under governmental controls, and whether an application provided by the service provider satisfies a critical process.

Block 610 of method 600 demonstrates determining risk factors. The system calculates a non-critical impact score using risk factors. Risk factors define the magnitude of the impact from the occurrence of a risk event. For each of the risk areas, the system 200 generates a risk factor score. Each risk factor score is generated based on the service provider information the system 200 receives. Information defining the risk factors may vary in format. The system provides a score based on such information. For example, the system may determine whether the service provider provides products or services based on open source technology. The information may simply be a simple yes or no. The system 200 may translate such into a numerical value, where yes may equal one. After the system 200 has scored the risk factor, the system may further apply a weighting factor to the risk factor. Such risk factor weighting value allows different risk factors to have different importance in calculating an inherent risk score, as defined herein. The system 200 may weight such a risk factor score depending on preconfigured risk factor weighting values. In the provided example, the risk factor for a service provider utilizing open source technology may have been assigned a numerical value of 0.50. The system 200 may weigh to the score of 1 with the risk factor weighting value of 0.5. Simply, the system 200 may perform a simple multiplication of the risk factor weighting value and the risk factor score, thus resulting in a weighted risk score of 0.5.

After the risk factors have been scored and weighted, the system 200 may calculate a non-critical impact score as depicted in block 615 of the method 600. A non-critical impact score may be simply calculated by using a summation of the weighted risk factor scores, as follows:

$$I = {\sum }_{n = 1}^{x} {W}_{n} ( {RE}_{n} ) + {W}_{n} ( {RE}_{n + 1} ) … + {W}_{x} ( {RE}_{x} )$$

Where x=the number of risk factors;

W=risk factor weighting value;

RE=risk factor score; and

I=non critical impact score.

Block 620 of method 600 demonstrates determining a number of critical applications that the service provider provides to the organization for which the system 200 is performing the risk analysis. As defined herein, a critical application is defined as an application which provides a product or service that is critical for business operation of the organization (i.e. a deposit application). Therefore, the risk of loss of such a product or service would fundamentally impact the ability of the organization to perform. The system 200 may determine the number of critical applications by communicating with the data store 122 or by communicating with the service provider as discussed within this application.

After the system 200 has determined CA and has calculated VLRA, the system may further calculate the impact score (SI). The SI is based on both VLRA and CA. This system 200 may calculate SI as follows:

SI=I+CA

Where I=non critical impact score;

CA=number of critical applications; and

SI=impact score.

Block 630 of method 600 demonstrates receiving risk probability information for a given service provider. The system 200 may receive the risk probability information in the same manner as receiving the risk impact information as demonstrated by block 605 of method 600. The risk probability information defines risk areas of the business of the service provider which may include, but is not limited to strategy, operations, reputation, compliance, finance, and market. Each risk area receives a raw score which is preconfigured either by the system 200 or by a third party from which the information was received. For example, for the operations risk area, the raw score may be based on an internal scorecard which may have a score from 0-100.

Similar to block 610, the system 200 scores each risk area on a preconfigured basis, thus resulting in a probability risk sub score for the risk area. In some embodiments, determining the score may comprise performing a table lookup using the raw score received in block 605. Each risk area may be associated with a different lookup table. In some embodiments, the results of the table may be standard across all the risk areas. For example, the system 200 may be preconfigured to provide a standard results of 1-5 based on the raw score of a given risk area. Where a first risk area has a score of 35 out of 50, the lookup table associated with the first risk area may define a score of 3 for any raw score that is in between 30-40. For a second risk area, the lookup table associated with the second risk area provides a score of 1-5 regardless of the range or scale of the table. Thus, all risk areas may be consistently scored regardless of how the risk areas are initially scored.

Block 640 of method 600 demonstrates calculating the inherent risk score. The system 200 may calculate the inherent risk score based on the probability risk sub score for each risk area and the SI. Specifically, the system may calculate a risk area impact score by multiplying the SI with the respective PS of the risk area, as follows:

RA=SI(PS)

Where RA =risk area impact score;

SI=impact score; and

PS=probability risk score.

After RA has been calculated, the inherent risk score may be calculated as follows:

$$I R S = {\sum }_{n = 1}^{x} R {A}_{n} + R {A}_{n + 1} … + R {A}_{x}$$

Where x=number of risk areas;

RA=risk area impact score; and

IRS=inherent risk score.

The inherent risk score provides a measurement to determine the amount of risk an organization assumes by receiving products or services form a service provider. When the system 200 calculates an inherent risk score for each service provider, each inherent risk score may be compared to determine service providers that would be considered high risk. The system may determine high risk service providers using statistical analysis based on the inherent risk score associated with each service provider. For example, the system 200 may calculate a median score based on each inherent risk score of the service providers and then determine a standard deviation using statistical analysis. The system 200 may then calculate determine that high risk service providers are those which have an inherent risk score outside one standard deviation above the median. In another embodiment, the system 200 may determine other tiers for determining the risk associated with a service provider.

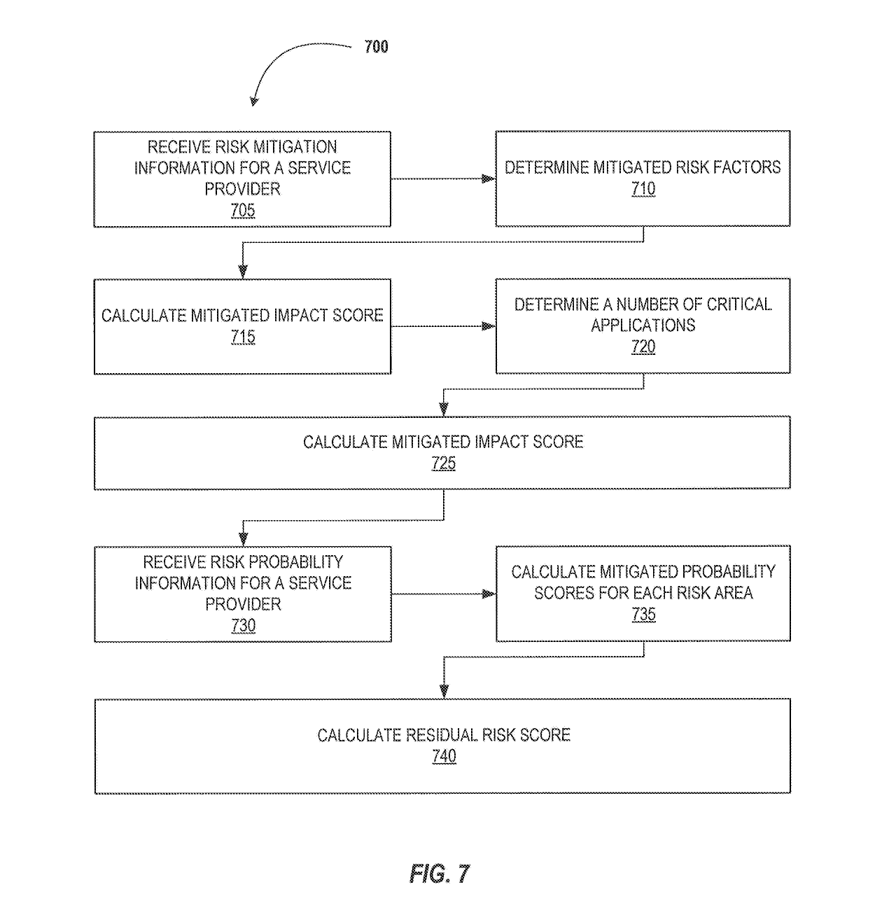

FIG. 7 depicts a method 700 for calculating a residual risk score of a service provider in accordance with various embodiments of the invention. The calculations and formulas used to calculate residual risk score are similar to that of inherent risk score. The system analyzes the reduction in risk that an organization assumes based on receiving products or services from a service provider. Such reduction is risk is based on implementing risk mitigation controls as defined within this specification. Because the inherent risk score and residual risk score calculations are similar, all portions mentioned in this specification relating to calculating inherent risk score shall apply to calculating residual risk score unless specifically identified otherwise. Where there are discrepancies between this and another portion of the specification, this section shall apply.

Block 705 demonstrates receiving risk mitigation information for a service provider. In addition to the information discussed in block 605, the information will further include information to determine risk mitigation controls. The data types of the information, the way the information is received, how the data is stored, and how the information is applied to the risk mitigation controls are similar as is described in block 605.

Block 710 demonstrates receiving mitigated risk factors. Similar to the non-critical impact score, the non-critical mitigated impact score is based on the risk factors used to calculate the non-critical impact score. The non-critical risk factors may be the same risk factors as described in block 610. The system 200 applies the risk mitigation controls to determine a reduction in the magnitude of an impact related to the occurrence of a risk event. The risk mitigation controls may be defined as a percentage reduction in the initial impact, thus resulting in a mitigated risk factor score. For example, the system may determine that a risk impact factor is mitigated by 45% based on an organization being able to implement a risk mitigation control. Therefore, the mitigated impact score may be determined based on the mitigation from the risk mitigation control. Similar to the risk factor scores, the mitigated risk factor scores may be weighted using a mitigated weighting factor. Therefore, different mitigated impact scores may have different weights of importance on the residual risk score.

After the risk mitigation control has been scored and weighted, the system 200 may calculate non-critical mitigated impact score. The system 200 may calculate the non-critical impact score similarly to the non-critical impact score calculation as explained in block 615 of method 600. The non-critical impact score may be calculated using the following equation:

$$IM = {\sum }_{n = 1}^{x} M {W}_{n} ( R {C}_{n} ) + M {W}_{n + 1} ( R {C}_{n + 1} ) … + M {W}_{x} ( R {C}_{x} )$$

Where x=number of risk mitigation controls;

MW=mitigated weighting factor

IM=non-critical mitigated impact score; and

RC=mitigated risk factor score.

Block 720 of method 700 demonstrates determining a number of critical applications. In some embodiments, this may be the same determination as described in block 620 of method 600 and no further request or receipt for information is necessary. In other embodiments, the process for receiving the number of critical applications is similar to that described in block 620 of method 600 but the system 200 performs this step apart from the step in block 620, this resulting is mitigated critical applications. The mitigated critical applications may be less than the number of critical applications based on the mitigated risk controls. Regardless of how and when the number of mitigated critical applications is determined, the number of non-critical mitigated applications may be defined as the number of critical applications that a service provider provides to an organization.

Block 725 of method 700 demonstrates calculating the mitigated impact score.

The system may calculate the mitigated impact score using the following equation:

SIM=IM+CAM

Where SIM=mitigated impact score;

IM=non-critical mitigated impact score; and

CAM=number of mitigated critical applications.

Block 730 of method 700 demonstrates receiving risk probability mitigation information for a service provider which is used to calculate a mitigated probability score for a given risk area. The risk areas described in this section may be identical to the risk areas described in block 630 of method 600 and in other areas of the specification. The system 200 takes into account the risk mitigation controls in determining the mitigated probability score. The risk mitigation controls reduce the probability of an occurrence of a risk event within a given risk area. The mitigation of the mitigated probability score may be defined as a percentage. For example, the system 200 may determine that a probability of occurrence of a risk event associated with a risk area is mitigated by 45% based on an organization enacting a risk mitigation control. The method for receiving such information and scoring the mitigated probability scores is similar to that described in the respective sections found in method 600.

After each mitigated probability score has been determined for the various risk areas, the system 200 may then calculate a mitigated risk probability area score for each risk area. The system 200 may calculate mitigated risk probability area score as follows:

RAM=SIM (PSM)

Where RAM=mitigated risk probability area score;

SIM=mitigated impact score; and

PSM=mitigated probability score.

The system 200 may calculate the residual risk score based on each mitigated risk probability area score associated with the individual risk areas. The system may calculate residual risk score as follows:

$$R R S = {\sum }_{n = 1}^{x} R A {M}_{n} + R A {M}_{n + 1} … + R A {M}_{x}$$

Where x=number of risk areas;

RAM=mitigated risk probability area score; and

RRS=residual risk score.

Residual risk score, similar to inherent risk score, is a score used to define the amount of risk associated with receiving products or services from a service provider. However, residual risk score further takes into account the ability of an organization to enact risk mitigation controls, as defined herein, to minimize such risk. The residual risk score represents the amount of risk remaining after the controls have been enacted. As such, by using inherent risk score and residual risk score together, the system 200 may further determine a reduction in risk amount by enacting said controls. The system 200 may further use residual risk score to determine high risk service providers as described in this specification and other tiers.

The system 200 may be further configured to include a feature to store calculated scores over a period of time. The system 200 may be configured to store these scores on a periodic basis or present a graphical user interface to the user via the user computing device 120 to store such data. The system 200 may store such historical data in the data store 122 and retrieve the data based on the needs of the user. The system may compile such historical data into a chart or graph and present such data to the user via the user computing device 120.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A service provider risk management system operated by an organization, comprising:
a processor;
a memory;
a communication interface in communication with a distributed network, the distributed network comprising one or more data stores having service provider information regarding a multitude of service providers stored therein;
a service provider risk management module stored in the memory, executable by the processor and configured for:
receiving, via network data feeds through the distributed network, service provider information for the multitude of service providers from the one or more data stores, wherein the multitude of service providers each provide a product or service to the organization, wherein the service provider information includes risk information for each of the multitude of service providers;
determining at least one risk area associated with a business practice of the multitude of service providers;
determining at least one risk factor associated with the multitude of service providers, wherein the risk factor is a result of the organization transacting with each of the multitude of service providers;
calculating an inherent risk score for each of the multitude of service providers based on the service provider information, wherein the inherent risk score is based on the at least one risk area and the at least one risk factor;
identifying risk mitigation controls for each of the multitude of service providers to mitigate an impact of the at least one risk factor and a probability of a risk event occurring in the at least one risk area;
calculating a residual risk score for each of the multitude of service providers based on the service provider information and identifying the risk mitigation controls for each of the multitude of service providers; and
presenting a graphical representation of at least the inherent risk score and the residual risk score for at least one of the multitude of service providers to a user computing device, whereby the service provider risk management system enables the organization to mitigate risk as a result of the organization receiving the product or service from the multitude of service providers by enacting the risk mitigation controls.

2. The service provider risk management system of claim 1, wherein the service provider risk management module is further configured for:
calculating an impact score for each of the multitude of service providers based on the risk information and based on the at least one risk factor;
determining for each of the multitude of service providers a probability of a risk event occurring in the at least one risk area based on the risk information;
calculating a probability risk score for the at least one risk area for each of the multitude of service providers based on determining the probability of the risk event occurring in the at least one risk area;
determining for each of the multitude of service providers an inherent risk area score for the at least one risk area based on the impact score and the probability risk score for the at least one risk area;
wherein calculating the inherent risk score for each of the multitude of service providers is based on the inherent risk area score for the at least one risk area.

3. The service provider risk management system of claim 1, wherein the service provider risk management module is further configured for:
calculating a residual impact score for each of the multitude of service providers based on the risk information, based on the at least one risk factor, and based on the risk mitigation controls;
determining for each of the multitude of service providers the probability of a risk event occurring in the at least one risk area based on the risk information and based on the risk mitigation controls;
calculating a residual probability risk score for the least one risk area for each of the multitude of service providers based on determining the probability of a risk event occurring in the at least one risk area and based on the risk mitigation controls;
determining for each of the multitude of service providers a residual risk area score for the at least one risk area based on the residual impact score and the residual probability risk score for the at least one risk area;
wherein calculating the residual risk score for each of the multitude of service providers is based on the residual risk area score for the at least one risk area.

4. The service provider risk management system of claim 1, wherein:
a service-provider system of one of the multitude of service providers is in communication with the distributed network and a data server of the organization is in communication with the distributed network; and
determining the at least one risk factor comprises determining whether the service-provider system has access to the data server of the organization.

5. The service provider risk management system of claim 1, wherein:
the inherent risk score for each of the multitude of service providers comprises an inherent risk area score associated with the at least one risk area;
the residual risk score for each of the multitude of service providers comprises a probability risk area score associated with the at least one risk area; and
the graphical representation is a radar chart, wherein the radar chart displays at least one inherent risk area score and at least one residual risk area score for at least one of the multitude of service providers.

6. The service provider risk management system of claim 1, wherein the graphical representation is a Pareto chart, wherein the Pareto chart displays the inherent risk score and the residual risk score of each of the multitude of service providers, and wherein the multitude of service providers are ranked in the Pareto chart ranked based on the inherent risk score of each of the multitude of service providers.

7. The service provider risk management system of claim 1, wherein the organization is a financial institution.

8. A computer program product for assessing and managing risk associated with a multitude of service providers comprising a non-transitory computer-readable storage medium having computer-executable instructions for:
receiving, via network data feeds through a distributed network, service provider information for the multitude of service providers from one or more data stores having the service provider information stored therein, wherein the multitude of service providers each provide a product or service to an organization, wherein the service provider information includes risk information for each of the multitude of service providers, wherein the distributed network comprises the one or more data stores;
determining at least one risk area associated with a business practice of the multitude of service providers;
determining at least one risk factor associated with the multitude of service providers, wherein the risk factor is a result of an organization transacting with each of the multitude of service providers;
calculating an inherent risk score for each of the multitude of service providers based on the service provider information, wherein the inherent risk score is based on the at least one risk area and the at least one risk factor;
identifying risk mitigation controls for each of the multitude of service providers to mitigate an impact of the at least one risk factor and a probability of occurrence of a risk event occurring in the at least one risk area;
calculating a residual risk score for each of the multitude of service providers based on the service provider information and identifying the risk mitigation controls for each of the multitude of service providers; and
presenting a graphical representation of at least the inherent risk score and the residual risk score for at least one of the multitude of service providers to a user computing device, whereby the computer program product enables the organization to mitigate risk as a result of the organization receiving products or services from the multitude of service providers by enacting the risk mitigation controls.

9. The computer program product of claim 8, wherein the non-transitory computer-readable storage medium has computer-executable instructions for:
calculating an impact score for each of the multitude of service providers based on the risk information and based on the at least one risk factor;
determining for each of the multitude of service providers the probability of a risk event occurring in the at least one risk area based on the risk information;
calculating a probability risk score for the at least one risk area for each of the multitude of service providers based on determining the probability of the risk event occurring in the at least one risk area;
determining for each of the multitude of service providers an inherent risk area score for the at least one risk area based on the impact score and the probability risk score for the at least one risk area;
wherein calculating the inherent risk score for each of the multitude of service providers is based on the inherent risk area score for the at least one risk area.

10. The computer program product of claim 8, wherein the non-transitory computer-readable storage medium has computer-executable instructions for:
calculating a residual impact score for each of the multitude of service providers based on the risk information, based on the at least one risk factor, and based on the risk mitigation controls;
determining for each of the multitude of service providers the probability of a risk event occurring based on the risk information and based on the risk mitigation controls;
calculating a residual probability risk score for the least one risk area for each of the multitude of service providers based on determining the probability of the risk event occurring in the at least one risk area and based on the risk mitigation controls;
determining for each of the multitude of service providers a residual risk area score for the at least one risk area based on the residual risk impact score and the residual probability risk score for the one risk area;
wherein calculating the residual risk score for each of the multitude of service providers is based on the residual risk area score for the at least one risk area.

11. The computer program product of claim 8, wherein a service-provider system of one of the multitude of service providers is in communication with the distributed network and a data server of the organization is in communication with the distributed network; and determining the at least one risk factor comprises determining whether the service-provider system has access to the data server of the organization.

12. The computer program product of claim 8, wherein: the inherent risk score for each of the multitude of service providers comprises an inherent risk area score associated with the at least one risk area;
the residual risk score for each of the multitude of service providers comprises a probability risk area score associated with the at least one risk area; and
the graphical representation is a radar chart, wherein the radar chart displays at least the inherent risk area score and the probability risk area score for at least one of the multitude of service providers.

13. The computer program product of claim 8, wherein the graphical representation is a Pareto chart, wherein the Pareto chart displays at the inherent risk score and the residual risk score for each of the multitude of service providers, wherein the multitude of service providers are ranked in the Pareto chart based on the inherent risk score of each of each of the multitude of service providers.

14. The computer program product of claim 8, wherein the organization is a financial institution.

15. A method for assessing and managing a service provider risk, comprising:
receiving, via network data feeds through a distributed network, service provider information for a multitude of service providers from one or more data stores having the service provider information stored therein, wherein the multitude of service providers each provide a product or service to an organization, wherein the service provider information includes risk information for each of the multitude of service providers, wherein the distributed network comprises the one or more data stores;
determining at least one risk area associated with a business practice of the multitude of service providers,
determining at least one risk factor associated with the multitude of service providers, wherein the risk factor is a result of an organization transacting with each of the multitude of service providers;
calculating an inherent risk score for each of the multitude of service providers based on the service provider information, wherein the inherent risk score is based on the at least one risk area and the at least one risk factor;
identifying risk mitigation controls for each of the multitude of service providers to mitigate an impact of the at least one risk factor and a probability of occurrence of a risk event occurring in the at least one risk area;
calculating a residual risk score for each of the multitude of service providers based on the service provider information and identifying the risk mitigation controls for each of the multitude of service providers; and
presenting a graphical representation of at least the inherent risk score and the residual risk score for at least one of the multitude of service providers to a user computing device, whereby the method enables the organization to mitigate risk as a result of the organization receiving products or services from the multitude of service providers be enacting the risk mitigation controls.

16. The method of claim 15, further comprising:
calculating an impact score for each of the multitude of service providers based on the risk information and based on the at least one risk factor;
determining for each of the multitude of service providers the probability of a risk event occurring in the at least one risk area based on the risk information;
calculating a probability risk score for the at least one risk area for each of the multitude of service providers based on determining the probability of the probability of the risk event occurring in the at least one risk area;
determining for each of the multitude of service providers an inherent risk area score for the at least one risk area based on the impact score and the probability risk score for the at least one risk area;
wherein calculating the inherent risk score for each of the multitude of service providers is based on the inherent risk area score for the at least one risk area.

17. The method of claim 15, further comprising:
calculating a residual impact score for each of the multitude of service providers based on the risk information, based on the at least one risk factor, and based on the risk mitigation controls;
determining for each of the multitude of service providers the probability of a risk event occurring in the at least one risk area based on the risk information and based on the risk mitigation controls;
calculating a residual probability risk score for the least one risk area for each of the multitude of service providers based on determining the probability of a risk event occurring in the at least one risk area and based on the risk mitigation controls;
determining for each of the multitude of service providers a residual risk area score for the at least one risk area based on the residual impact score and the residual probability risk score for the at least one risk area;
wherein calculating the residual risk score for each of the multitude of service providers is based on the residual risk area score for the at least one risk area.

18. The method of claim 15, wherein a service-provider system of one or the multitude of service providers is in communication with the distributed network and a data server of the organization is in communication with the distributed network; and determining the at least one risk factor comprises determining whether the service-provider system has access to the data server of the organization.

19. The method of claim 15, wherein: the inherent risk score for each of the multitude of service providers comprises an inherent risk area scores associated with the at least one risk area;
the residual risk score for each of the multitude of service providers comprises a probability risk area score associated with the at least one risk area; and
the graphical representation is a radar chart, wherein the radar chart displays at least the inherent risk area score and the probability risk area score for at least one of the multitude of service providers.

20. The method of claim 15, wherein the organization is a financial institution.
